(19) United States
(12) Patent Application Publication
(10) Pub. No.: US 2026/0358184 A1
(43) Pub. Date: Nov. 12, 2026

(54) METHOD FOR MEASURING AND SENSOR DEVICE

(71) Applicant: Robert Bosch GmbH, Stuttgart (DE)

(72) Inventors: Clemens Boucsein, Kirchzarten (DE); Carsten Klein, Kusterdingen (DE)

(21) Appl. No.: 19/670,508

(22) Filed: May 7, 2026

(30) Foreign Application Priority Data
May 12, 2025 (DE) 10 2025 118 129.2

(51) Int. Cl. G01L 27/00

(52) U.S. Cl. CPC G01L 27/00

(57) ABSTRACT

A method for measuring at least one measurand. The method includes: providing a sensor group of reference sensors for measuring the measurand and at least one further reference sensor for measuring the measurand; a first measurement operation, in which the measurand is measured simultaneously by each of the reference sensors of the sensor group, and providing the individual measurement signals of the reference sensors generated thereby; a second measurement operation, in parallel with the first measurement operation, in which the measurand is measured by the further reference sensor at a sampling rate different from that of the first measurement operation, and providing the further measurement signal of the further reference sensor generated thereby; and calculating a common output measurement signal at least depending on the individual measurement signals of the sensor group and the further measurement signal. A sensor device is also described.

### CROSS REFERENCE

The present application claims the benefit under 35 U.S.C. § 119 of Germany Patent Application No. DE 10 2025 118 129.2 filed on May 12, 2025, which is expressly incorporated herein by reference in its entirety.

### FIELD

The present disclosure relates to a method for measuring. The present disclosure furthermore relates to a sensor device.

### BACKGROUND INFORMATION

MEMS sensors can now be more accurate and less noisy than many commercially available reference sensors, which makes calibration more difficult. For technical reasons, the reference sensors exhibit particular strengths in the key parameters of absolute accuracy, repeatability, long-term stability, noise amplitude, and readout frequency. If some of these characteristic variables are optimized, this is achieved only at the expense of the other characteristic variables. For example, the noise amplitude can be improved by averaging a plurality of measurement cycles, although this reduces the readout frequency or the temporal resolution. If, by contrast, the readout frequency is optimized, this is in turn accompanied, for technical reasons, by high signal noise and usually also a high long-term drift.

### SUMMARY

According to the present disclosure, a method for measuring is provided. According to an example embodiment, the method includes: providing a sensor group of reference sensors for measuring the measurand and at least one further reference sensor for measuring the measurand; a first measurement operation, in which the measurand is measured simultaneously by each of the reference sensors of the sensor group, and providing the individual measurement signals of the reference sensors generated thereby; a second measurement operation, in parallel with the first measurement operation, in which the measurand is measured by the further reference sensor at a sampling rate different from that of the first measurement operation, and providing the further measurement signal of the further reference sensor generated thereby; and calculating a common output measurement signal at least depending on the individual measurement signals of the sensor group and the further measurement signal.

This allows the measurement of the measurand to be carried out with reduced stochastic noise (Brownian molecular motion, electrical noise, electronic noise) while simultaneously being highly precise, with a large bandwidth and a high sampling rate. The noise amplitude can be reduced with high temporal resolution (bandwidth). The long-term stability and repeatability of the measurement can be increased.

The method for measuring can be carried out in order to characterize a sensor to be tested. The method for measuring can implement a reference measurement. The output measurement signal can serve as a reference measurement signal. The sensor to be tested can provide a measurement signal by measuring the measurand. The sensor to be tested can be characterized on the basis of a comparison between the measurement signal of the sensor to be tested and the reference measurement signal. The reference measurement and the sensor to be tested can measure the same measurand.

The measurand can be a physical, chemical, or other variable that can be clearly ascertained by measurement technology. The measurand can be an environmental variable (of an environment). A time profile of the measurand can be used as a basis for characterizing a sensor to be tested. The measurand can be a scalar quantity (temperature, pressure, concentration), a vector quantity (linear acceleration, magnetic flux density), or a derived quantity (angular velocity, sound power).

The reference sensors can each form functional (structural) units that can convert the measurand into an evaluable electrical, optical, magnetic or other measurement signal. The reference sensors can be microelectromechanical (MEMS) sensors. The reference sensors can measure the measurand piezoresistively, piezoelectrically, capacitively, inductively, magnetoresistively, optically (interferometrically, photometrically), electromagnetically, resonantly, and/or thermoelectrically. The reference sensors can be pressure sensors used to measure ambient pressure as the measurand.

The (further) measurement signal can be the electrically, optically or otherwise encoded representation of the measurand. The (further) measurement signal can be a raw signal or a (pre-) processed input signal.

The reference sensors of the sensor group can be statistically independent of one another. The reference sensors of the sensor group can measure the measurand independently of one another.

The reference sensors of the sensor group can together form a sensor array.

The measurand can be measured by the reference sensors simultaneously (synchronously) with the first measurement operation. The reference sensors can measure the measurand at the same (absolute) times (sampling times).

The output measurement signal can be provided (stored) via an interface. The interface can be SPI, I2C, Ethernet and/or USB.

In a preferred example embodiment of the present disclosure, it is advantageous if the sampling rate of the further reference sensor is smaller than the sampling rate of the reference sensors during the first measurement operation. The sampling rate can be the number of discrete samples per unit of time (second). The additional reference sensor can have higher long-term stability, higher repeatability and/or measurement accuracy than the reference sensors.

In an advantageous example embodiment of the present disclosure, the individual measurement signals are converted into a first contribution signal by a first processing operation. The first contribution signal can, depending on the number n of reference sensors, have a noise level theoretically reduced by 1/\sqrt{n}.

In a preferred example embodiment of the present disclosure, the first processing operation comprises averaging and/or high-pass filtering. The averaging can be performed by point-to-point averaging (without temporal smoothing). The first processing operation can calculate an average value of individual measurement values of the plurality of reference sensors recorded simultaneously at a discrete sampling time.

The averaging in the first measurement operation can, for the sensor group consisting of n, form, using the individual measurement value xᵢ[k] of the i-th reference sensor at the discrete sampling index k (corresponding to the sampling time tₖ), an averaged contribution signal value y[k] of the first contribution signal as follows:

$$y [ k ] = \frac{1}{n} {\sum }_{i = 1}^{n} {x}_{i} [ k ]$$

The first contribution signal can be filtered using high-pass filtering in the first processing operation. The first contribution signal can primarily have high-frequency signal components.

In a specific example embodiment of the present disclosure, it is advantageous if the further measurement signal is converted into a second contribution signal by a second processing operation. The second contribution signal can be forecast (interpolated) to align the sampling times with the first contribution signal (by upsampling). Interpolation can increase the sampling rate of the further measurement signal to the time grid of the sensor group. As a result, an interpolated measurement value of the reference sensor can be generated for each sampling time of the sensor group. This allows the first and the second contribution signal to be synchronized with respect to the sampling times. The interpolation can be a linear, spline-based, and/or polynomial interpolation.

In a specific example embodiment of the present disclosure, it is advantageous if the second processing operation comprises low-pass filtering. As a result, the low-pass filtering can reduce the spectral components in the further measurement signal that arose during interpolation. Due to the low-pass filtering, the second contribution signal can include only the frequency components in which the further reference sensor has high measurement accuracy.

A preferred example embodiment of the present disclosure is advantageous in which the common output measurement signal is formed by combining the first and the second contribution signal. The combining (data fusion) can comprise summing the first and the second contribution signal. The output measurement signal can have combined frequency bands (which previously differed due to the high-pass filtering and low-pass filtering) of the first and the second contribution signal.

In a specific example embodiment of the present disclosure, it is advantageous if the high-pass filtering and the low-pass filtering are coordinated with one another such that the combined output measurement signal has the full signal amplitude at every signal frequency. At each frequency point (each signal frequency value), the sum of the first and the second contribution signal can complement one another to form the full amplitude (signal amplitude). This makes it possible to prevent level loss and amplitude distortion when the first and the second contribution signal are combined.

The magnitude transfer functions (the magnitude frequency response, the amplitude frequency response) of the high-pass filtering in the first processing operation and the low-pass filtering in the second processing operation can complement one another over the entire frequency spectrum at each frequency to form a constant value (1, 0 dB).

The cutoff frequency of the low-pass filtering can be complementary to the cutoff frequency of the high-pass filtering of the first processing path. The cutoff frequency can be the frequency at which the magnitude transfer function of the filter has dropped to −3 dB.

The magnitude transfer functions (the magnitude frequency response, the amplitude frequency response) of the high-pass filtering in the first processing operation and the low-pass filtering in the second processing operation can complement one another over the entire frequency spectrum at each frequency to equal 1 (0 dB).

The magnitude transfer functions of high-pass filtering and low-pass filtering can be complementary to one another (mirror image, reciprocal, symmetrical). For example, in the frequency range in which the high-pass filtered first contribution signal of the sensor group still shows a gain decreasing from 1, the low-pass filtering may already have a gain increasing from 0.

In an overlap band of the magnitude transfer functions of the high-pass filtering and the low-pass filtering, oppositely extending slopes may be present, in particular to keep the sum equal to 1.

In a preferred example embodiment of the present disclosure, the reference sensors of the sensor group are identical in construction to one another, and the further reference sensor is constructed differently from the sensors of the sensor group. The reference sensors of the sensor group can be functionally identical. The reference sensors of the sensor group can have the same noise characteristics and sensitivity.

According to the present disclosure, a sensor device is also provided. The sensor device can have a housing that accommodates the sensor group, the reference sensor, and the signal processing unit. The sensor device can be constructed as a module.

The features inserted in parentheses in the preceding and following description, possibly separated by commas and therefore to be taken individually or in combination with one another, are to be understood as alternative, optional, supplementary, restrictive, clarifying, exemplary, expansive, abbreviating, and/or explanatory information relating to the feature(s) immediately preceding and/or following the parentheses.

Further advantages and advantageous configurations of the subject matter of the present disclosure can be found in the description of the figures and in the figures.

### BRIEF DESCRIPTION OF THE DRAWINGS

The present disclosure is described in detail below with reference to the figures.

FIG. 1 shows a method for measuring in a specific example embodiment of the present disclosure.

FIG. 2 shows a characteristic diagram of an amplitude frequency response of each of a low-pass filtering and a high-pass filtering of a method in a further specific example embodiment of the present disclosure.

### DETAILED DESCRIPTION OF EXAMPLE EMBODIMENTS

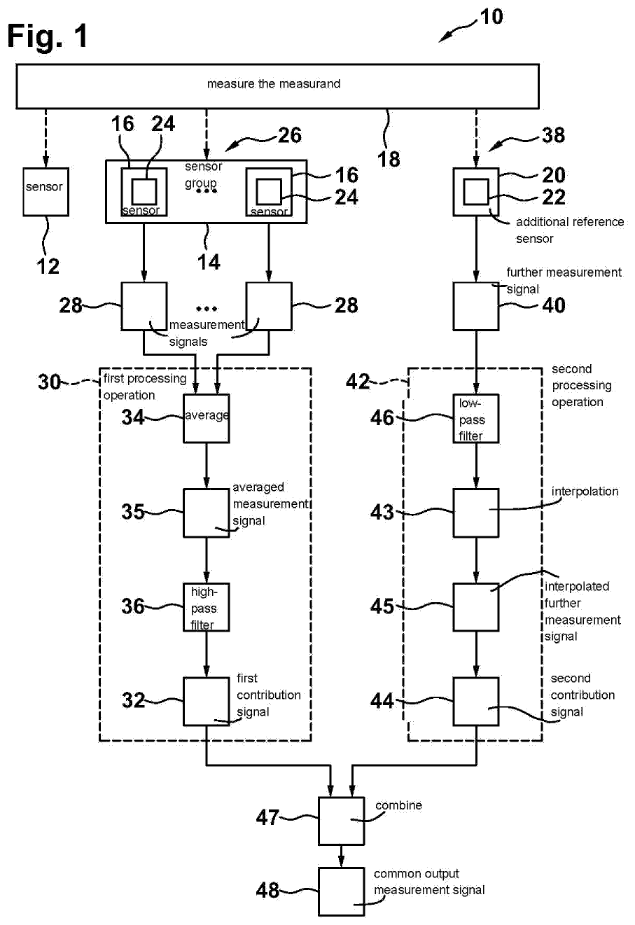

FIG. 1 shows a method for measuring in a specific example embodiment of the present disclosure. The method for measuring 10 can be used to characterize a sensor 12 to be tested, for example a pressure sensor. The method for measuring 10 can perform a reference measurement of the measurand with which the sensor 12 to be tested can be characterized.

The method for measuring 10 initially comprises providing a sensor group 14 of reference sensors 16 for measuring the measurand 18. The reference sensors 16 of sensor group 14 are identical in construction to one another. Furthermore, at least one additional reference sensor 20 is provided for measuring the measurand 18. The additional reference sensor 20 is constructed differently than the reference sensors 16 of the sensor group 14 and has, in particular, a higher measurement accuracy and long-term stability than the reference sensors 16 of the sensor group 14. For this purpose, the sampling rate 22 of the further reference sensor 20 can be smaller than the sampling rate 24 of each of the reference sensors 16.

Furthermore, a first measurement operation 26 is carried out, in which the measurand 18 is measured simultaneously by each of the reference sensors 16 of the sensor group 14 and the individual measurement signals 28 of the reference sensors 16 generated thereby are provided. The individual measurement signals 28 are converted into a first contribution signal 32 by a first processing operation 30, and the first contribution signal 32 is provided.

The first processing operation 30 comprises, in particular, averaging 34 the plurality of signal values at a particular sampling time (measurement time). This results in averaged signal values for each sampling time. This time-discretely averaged measurement signal 35 is then filtered by high-pass filtering 36, and the measurement signal filtered in this way forms the first contribution signal 32.

Furthermore, a second measurement operation 38 is carried out in parallel with the first measurement operation 26, in which second measurement operation the measurand 18 is measured by the further reference sensor 20 at a sampling rate 22 different from that of the first measurement operation 26 and a further measurement signal 40 of the further reference sensor 20 is provided. The further measurement signal 40 is converted into a second contribution signal 44 by a second processing operation 42, and the second contribution signal 44 is provided.

The second processing operation 42 comprises, in particular, aligning the sampling times of the further measurement signal 40 with the first contribution signal 32 by interpolation 43. The interpolation 43 can increase the sampling rate of the further measurement signal 40 to the time grid of the first contribution signal 32. Furthermore, the second processing operation 42 comprises low-pass filtering 46, which filters the interpolated further measurement signal 45 and provides the measurement signal thus filtered as the second contribution signal 44.

Furthermore, a common output measurement signal 48 is formed depending on the individual measurement signals 28 of the sensor group 14 and of the further measurement signal 40, in particular the first and the second contribution signal 32, 44. The common output measurement signal 48 is formed by combining 47 (summing) the first and the second contribution signal 32, 44.

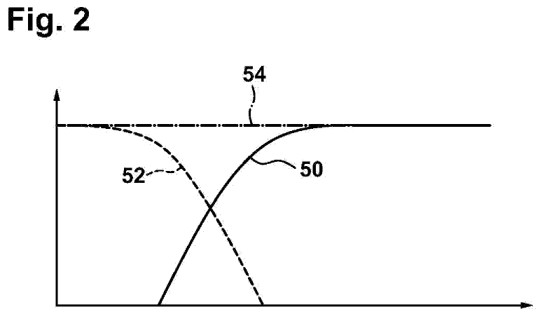

FIG. 2 shows a characteristic diagram of an amplitude frequency response of each of the low-pass filtering and high-pass filtering of a method in a further specific embodiment of the present disclosure. The high-pass filtering and the low-pass filtering are coordinated with one another in such a way that the combined (summed) output measurement signal has the full signal amplitude (is undamped) at every signal frequency, i.e., the superimposed amplitude frequency response 54 is constant. The amplitude frequency response 50 of the high-pass filtering and the amplitude frequency response 52 of the low-pass filtering extend such that the transmission factor is constant in sum.

What is claimed is:

1. A method for measuring a measurand, the method comprising the following steps:
providing a sensor group of reference sensors for measuring the measurand, and at least one further reference sensor for measuring the measurand;
performing a first measurement operation, in which the measurand is measured simultaneously by each of the reference sensors of the sensor group, and providing individual measurement signals of the reference sensors generated thereby;
performing a second measurement operation, in parallel with the first measurement operation, in which the measurand is measured by the further reference sensor at a sampling rate different from a sampling rate of the reference sensors of the sensor group during the first measurement operation, and providing a further measurement signal of the further reference sensor generated thereby; and
calculating a common output measurement signal at least depending on the individual measurement signals of the reference sensors of the sensor group and the further measurement signal.

2. The method for measuring according to claim 1, wherein the sampling rate of the further reference sensor is smaller than a sampling rate of the reference sensors during the first measurement operation.

3. The method for measuring according to claim 1, wherein the individual measurement signals of the reference sensors of the sensor group are converted into a first contribution signal by a first processing operation.

4. The method for measuring according to claim 3, wherein the first processing operation includes averaging and/or high-pass filtering.

5. The method for measuring according to claim 3, wherein the further measurement signal is converted into a second contribution signal by a second processing operation.

6. The method for measuring according to claim 5, wherein the second processing operation includes low-pass filtering.

7. The method for measuring according to claim 5, wherein the common output measurement signal is formed by combining the first contribution signal and the second contribution signal.

8. The method for measuring according to claim 7, wherein the first processing operation includes averaging and/or high-pass filtering, wherein the second processing operation includes low-pass filtering, and wherein the high-pass filtering and the low-pass filtering are coordinated with one another such that the common output measurement signal has a full signal amplitude at every signal frequency.

9. The method for measuring according to claim 1, wherein the reference sensors of the sensor group are identical in construction to one another, and the further reference sensor is constructed differently from the reference sensors of the sensor group.

10. A sensor device for measuring a measurand, comprising:
a sensor group including reference sensors configured to measure the measurand;
at least one further reference sensor configured to measure the measurand; and
a signal processing unit configured to:
perform a first measurement operation, in which the measurand is measured simultaneously by each of the reference sensors of the sensor group, and provide individual measurement signals of the reference sensors generated thereby,
perform a second measurement operation, in parallel with the first measurement operation, in which the measurand is measured by the further reference sensor at a sampling rate different from a sampling rate of the reference sensors of the sensor group during the first measurement operation, and provide a further measurement signal of the further reference sensor generated thereby, and
calculate a common output measurement signal at least depending on the individual measurement signals of the reference sensors of the sensor group and the further measurement signal.
